(19) United States
(12) Patent Application Publication
(10) Pub. No.: US 2020/0324153 A1
(43) Pub. Date: Oct. 15, 2020

(54) HARNESS MOUNTABLE INSULATING ASSEMBLY AND SYSTEM

(71) Applicant: Tethrd LLC, Jordan, MN (US)

(72) Inventors: Walter Ernest Power, II, Jordan, MN (US); Gregory Alan Godfrey, Richmond Hill, GA (US); Carl Eugene Kossuth, III, Jordan, MN (US)

(73) Assignee: Tethrd, LLC, Jordan, MN (US)

(21) Appl. No.: 16/381,648

(22) Filed: Apr. 11, 2019

(51) Int. Cl. A62B 35/00; A47C 3/025; A01M 31/02

(52) U.S. Cl. CPC A62B 35/0025; A01M 31/02; A47C 3/0255

(57) ABSTRACT

A harness mountable insulating assembly includes a panel that is flexible and has a front side, a back side and a perimeter edge. The perimeter edge includes an upper edge, a lower edge, a first lateral edge and a second lateral edge. A coupler attaches the panel to a safety harness so that panel extends downwardly to cover buttocks of a person using the safety harness. This positioning retains heat between the panel and the buttocks.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The invention is in the field of heat retention devices and such as those used by hunters who are positioned in tree stands or are supported by safety harness devices.

### (2) Description of Related Art Including Information Disclosed Under 37 CFR 1.97 and 1.98

The disclosure and prior art relates to personal insulating devices and more particularly pertains to a new personal insulating device for preventing heat loss in a person's buttocks area while they are using a safety harness.

### BRIEF SUMMARY OF THE INVENTION

An embodiment of the disclosure meets the needs presented above by generally comprising a panel that is flexible and has a front side, a back side and a perimeter edge. The perimeter edge includes an upper edge, a lower edge, a first lateral edge and a second lateral edge. A coupler attaches the panel to a safety harness so that panel extends downwardly to cover buttocks of a person using the safety harness. This positioning retains heat between the panel and the buttocks.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a rear isometric view of a harness mountable insulating assembly and system according to an embodiment of the disclosure.

FIG. 2 is a front view of an embodiment of the disclosure.

FIG. 3 is a cross-sectional view of an embodiment of the disclosure taken along line 3-3 of FIG. 1.

FIG. 4 is a front view of a panel of an embodiment of the disclosure attached to a rear side of a safety harness.

FIG. 5 is a rear in-use view of an embodiment of the disclosure.

### DETAILED DESCRIPTION OF THE INVENTION

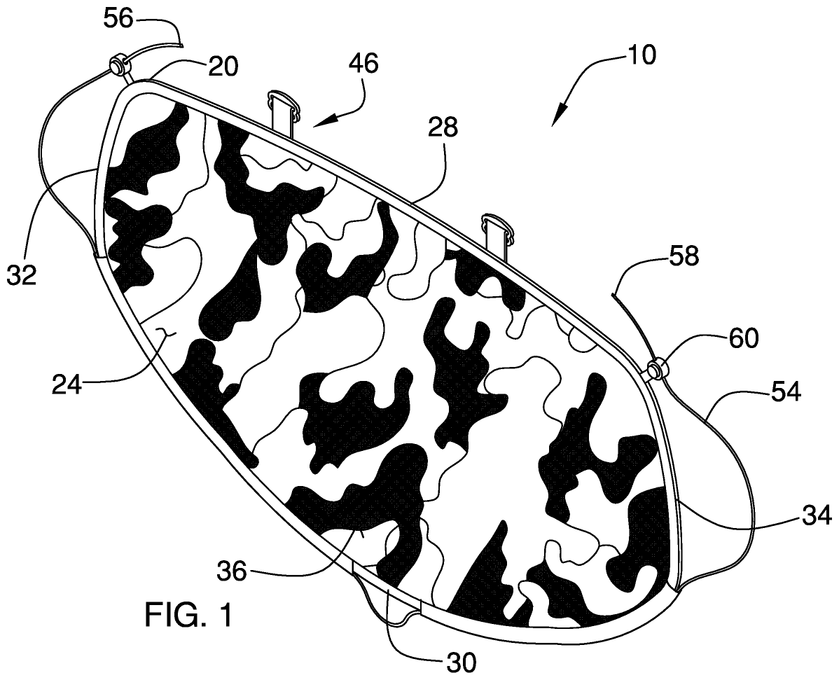

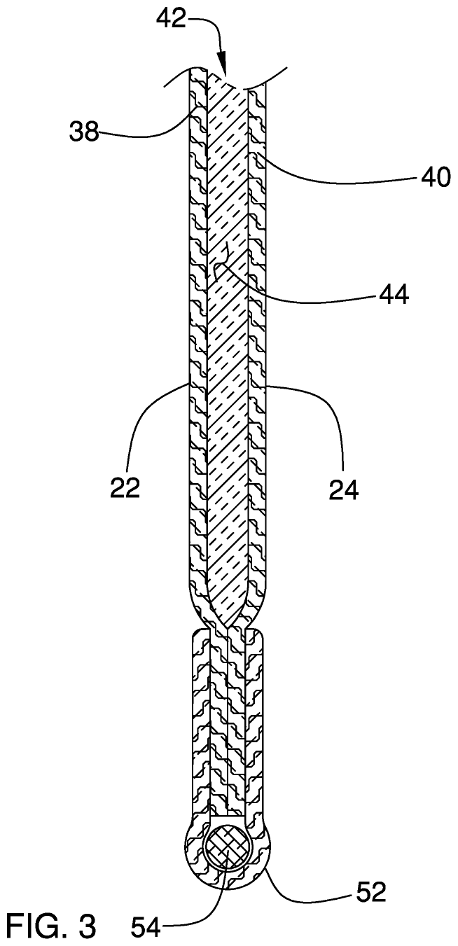

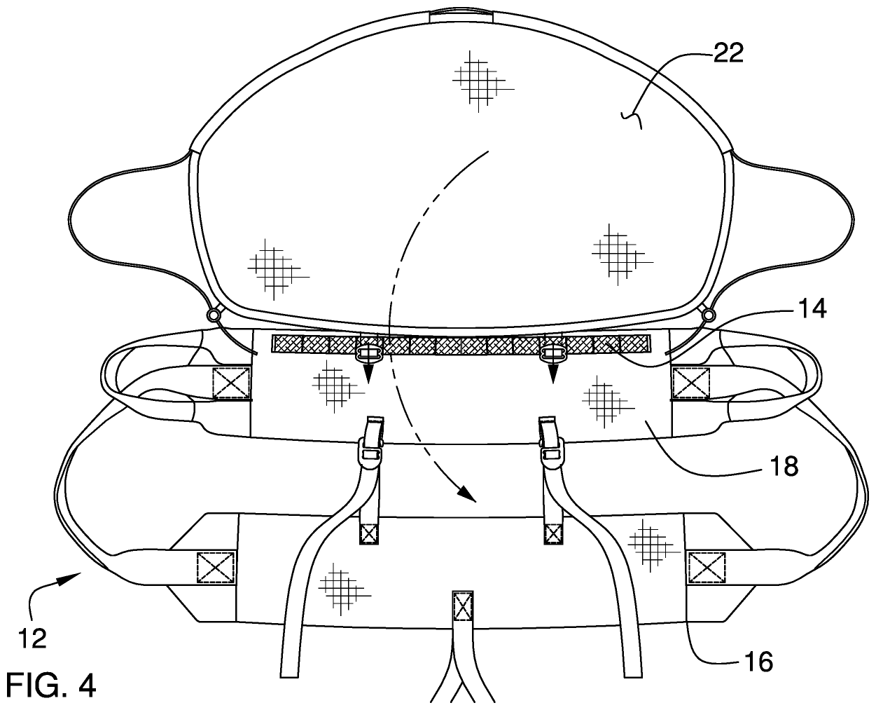

With reference now to the drawings, and in particular to FIGS. 1 through 5 thereof, a new personal insulating device embodying the principles and concepts of an embodiment of the disclosure and generally designated by the reference numeral 10 will be described.

As best illustrated in FIGS. 1 through 5, the harness mountable insulating assembly 10 and system generally comprises a personal insulating device that is used while saddle hunting. Saddle hunting is a term used by hunters who utilize safety harnesses 12 to support their weight while positioned in a tree and usually stand on a small tree stand attached to the tree. The safety harness 12 allows the hunter to freely rotate and move relative to the tree without fear of falling from the tree while providing additional stability while releasing an arrow or shooting a firearm. These harnesses typically include a pair of semi-circular loops including an upper cradle 18 and a lower cradle 16 wherein the upper cradle 18 will rest against the lower back of a person and the lower cradle 16 will be positioned one or adjacent to a juncture of the legs and buttocks. The user of such a harness “sits” on these upper 18 and lower 16 cradles and is thereby supported from a tree. However, this exposes the person's body between the upper 18 and lower 16 cradles to the elements and because the upper 18 and lower 16 cradles compress the person's clothing against their body, removing air that otherwise might be trapped in the clothing, heat is more quickly transferred through the clothing.

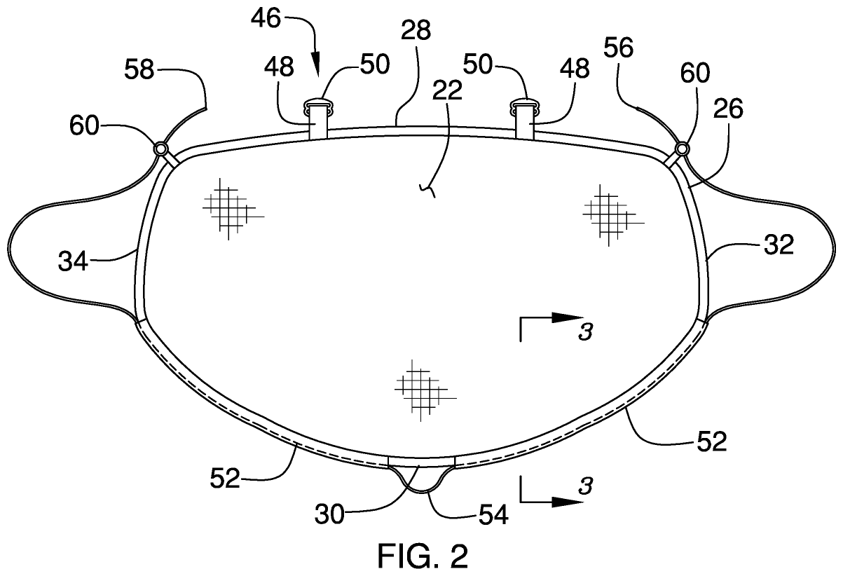

The assembly 10 is used to cover this exposed area and form a pocket of air between the assembly 10 and the person's clothes. The assembly 10 includes a panel 20 that is flexible and has a front side 22, a back side 24 and a perimeter edge 26. The panel 20 edge includes an upper edge 28, a lower edge 30, a first lateral edge 32 and a second lateral edge 34. The lower edge 30 is convexly arcuate and as can be seen in FIG. 2 the first 32 and second 34 lateral edges may be slightly arcuate as well, flaring outwardly first from the upper edge 28 and then arcing back to form the lower edge 30. The upper edge 28 will typically have a length from 12.0 inches to 36.0 inches. The first 32 and second 34 lateral edges each have a height that is between 4.0 inches and 12.0 inches. The back side 24 may have a camouflage indicia 36 positioned thereon to help conceal the person as they are hunting.

The panel 20 comprises an inner wall 38 and an outer wall 40 attached together along respective outer edges thereof. The inner wall 38 includes the front side 22 and the outer wall 40 includes the back side 24. Each of the inner 38 and outer 40 walls is comprised of a cloth material. The cloth material may comprise any conventional material used for hunting such as cotton, synthetic materials and the like. Other materials such as leather may be utilized though woven materials would generally be preferred for cost, ease of care and flexibility. An interior space 42 is defined between the inner 38 and outer 40 walls.

The panel 20 includes an insulating material 44 that is positioned in the interior space 42. The insulating material 44 inhibits thermal conductivity between the front 22 and back 24 sides, thereby trapping heat against the front side 22 as discussed below. Any conventional material used for insulating may be used including natural and synthetic insulators. One suitable material is Climashield available from Climashield, 641 Northpark Drive, Clinton, Tenn.

A coupler 46 attaches the panel 20 to the safety harness 12, and in particular the upper cradle 18, so that the panel 20 hangs downwardly from the upper cradle 18 to cover the buttocks which are exposed between the upper 18 and lower 16 cradles. The coupler 46 is releasable from the safety harness 12 to allow the user to determine if the assembly 10 will or will not be used with the safety harness 12. The coupler 46 may include one or more straps 48 that are attached to the panel 20 and extend upwardly from the upper edge 28. One or more connectors 50 are provided and attached to the straps 48 so that each of the straps 48 includes a connector 50. The connectors 50 may comprise typical MOLLE type connectors that are insertable into MOLLE type strapping 14. MOLLE, which may also be referred to as PALS, stands for, respectively, modular lightweight load-carrying equipment and pouch attachment ladder system. These labels are often interchangeable and define a ubiquitous coupling arrangement whereby a strap is attached to an article at approximately 1.5 inch increments to form closed loops between the attachment points. The closed loops are then used for receiving clips, other straps, or connectors such as shown in FIG. 1. Alternate coupling means may be utilized including snaps, buttons, hook and loop fasteners, zippers and the like.

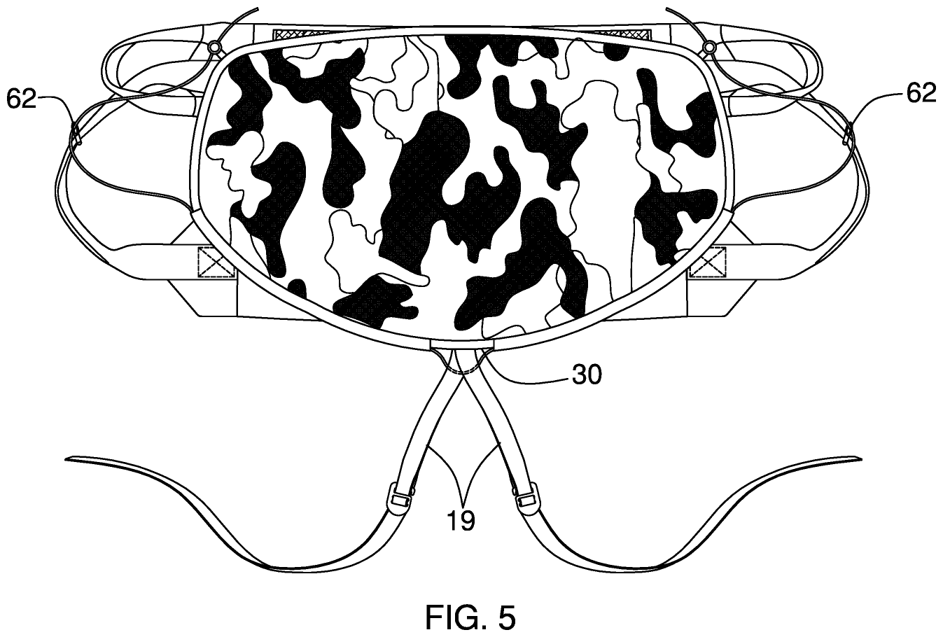

A plurality of sleeves 52 is attached to the perimeter edge. Term “attached” herein with respect to the sleeves 52 may include the sleeves being formed in the cloth material of the panel 20. The sleeves 52 are positioned at least on the lower edge 30 but may also be on the first 32 and second 34 lateral edges. A tether 54, of any conventional flexible cording, extends through the sleeves 52. The tether 54 has a first free end 56 and a second free end 58. The tether 54 may be pulled tight to cinch the perimeter edge 26, particularly along the lower edge 30, so that the panel 20 is tightened against the safety harness 12 and a user thereof. As can be seen in FIGS. 2 and 5, the sleeves 52 may have gaps to expose portions of the tether 54 so that strapping 19 from the safety harness 12 can be extended between the tether 54 and panel 20 and form connection points between the panel 20 and the safety harness 12. A pair of stops 60 is attached to perimeter edge 26. The stops 60 engage the tether 54 to releasably secure the tether 54 relative to the perimeter edge 26. One of the stops 60 positioned adjacent to the first free end 56 and one of the stops 60 is positioned adjacent to the second free end 58. The stops 60 may be comprised of any conventional cord locking/releasing mechanism and may include, for example, toggle spring stop string cord locks easily found from many suppliers.

A pair of clips 62 may be provided to further secure the tether 54 to the safety harness 12 to assist in its ability to trap air between the panel 20 and the safety harness 12. Each of the clips 62 is positioned on the tether 54 wherein one of the clips 62 is positioned adjacent to one of the stops 60 and one of the clips 62 is positioned adjacent to another one of the stops 60. The clips 62 are then used to engage strapping of or attached to the safety harness 12 to again allow for tightening of the panel 20 against the safety harness 12.

In use, when a hunter is cold, the hunter may secure the panel 20 to the safety harness 12 so that the harness 12 extends down over the buttocks area of the hunter to prevent air from freely moving across the buttocks. This traps the air between the panel 20 and the safety harness 12 to prevent heat loss. The panel 20 may be secured to the safety harness 12 by the coupler 46 as well as along multiple points of the tether 54. The tether 54 can thereafter be used to cinch the panel 20 tighter against the safety harness 12 to increase heat retention or can be loosened to facilitate heat release.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An insulating assembly for attachment to a harness such that the insulating assembly provides a layer of insulation between a person and ambient air, the insulating assembly comprising:
a panel being flexible and having a front side, a back side and a perimeter edge, the perimeter edge including an upper edge, a lower edge, a first lateral edge and a second lateral edge; and
a coupler attaching the panel to a safety harness wherein the panel is configured to cover a buttocks of a person using the safety harness to retain heat between the panel and the buttocks.

2. The insulating assembly according to claim 1, wherein the lower edge is convexly arcuate.

3. The insulating assembly according to claim 1, wherein the upper edge has a length between 12.0 inches and 36.0 inches, the first and second lateral edges each having a height being between 4.0 inches and 12.0 inches.

4. The insulating assembly according to claim 1, wherein the panel comprising an inner wall and an outer wall attached together along respective outer edges thereof, the inner wall including the front side and the outer wall including the back side, an interior space being defined between the inner and outer walls.

5. The insulating assembly according to claim 4, wherein the panel includes an insulating material being positioned in the interior space, the insulating material inhibiting thermal conductivity between the front and back sides.

6. The insulating assembly according to claim 1, wherein the coupler includes:
a strap being attached to the panel and extending upwardly from the upper edge;
a connector being attached to the strap, the connector being configured to engage a loop on the safety harness.

7. The insulating assembly according to claim 1, further including:
a plurality of sleeves being attached to the perimeter edge, the sleeves being positioned at least on the lower edge; and
a tether extending through the sleeves, the tether having a first free end and a second free end, the tether being pulled to cinch the perimeter edge.

8. The insulating assembly according to claim 7, further including a pair of stops being attached to perimeter edge, the stops engaging the tether to releasably secure the tether relative to the perimeter edge, one of the stops being positioned adjacent to the first free end and one of the stops being positioned adjacent to the second free end.

9. The insulating assembly according to claim 8, further including a pair of clips, each of the clips being positioned on the tether wherein one of the clips is positioned adjacent to one of the stops and one of the clips is positioned adjacent to another one of the stops, the clips being configured to engage strapping on the safety harness.

10. The insulating assembly according to claim 5, wherein the coupler includes:
a strap being attached to the panel and extending upwardly from the upper edge;
a connector being attached to the strap, the connector being configured to engage a loop on the safety harness.

11. The insulating assembly according to claim 10, further including:
a plurality of sleeves being attached to the perimeter edge, the sleeves being positioned at least on the lower edge; and
a tether extending through the sleeves, the tether having a first free end and a second free end, the tether being pulled to cinch the perimeter edge.

12. The insulating assembly according to claim 11, further including a pair of stops being attached to perimeter edge, the stops engaging the tether to releasably secure the tether relative to the perimeter edge, one of the stops being positioned adjacent to the first free end and one of the stops being positioned adjacent to the second free end.

13. The insulating assembly according to claim 12, further including a pair of clips, each of the clips being positioned on the tether wherein one of the clips is positioned adjacent to one of the stops and one of the clips is positioned adjacent to another one of the stops, the clips being configured to engage strapping on the safety harness.

14. The insulating assembly according to claim 5, further including:
a plurality of sleeves being attached to the perimeter edge, the sleeves being positioned at least on the lower edge; and
a tether extending through the sleeves, the tether having a first free end and a second free end, the tether being pulled to cinch the perimeter edge.

15. The insulating assembly according to claim 14, further including a pair of stops being attached to perimeter edge, the stops engaging the tether to releasably secure the tether relative to the perimeter edge, one of the stops being positioned adjacent to the first free end and one of the stops being positioned adjacent to the second free end.

16. The insulating assembly according to claim 15, further including a pair of clips, each of the clips being positioned on the tether wherein one of the clips is positioned adjacent to one of the stops and one of the clips is positioned adjacent to another one of the stops, the clips being configured to engage strapping on the safety harness.

17. An insulating assembly for attachment to a harness such that the insulating assembly provides a layer of insulation between a person and ambient air, the insulating assembly comprising:
a panel being flexible and having a front side, a back side and a perimeter edge, the panel edge including an upper edge, a lower edge, a first lateral edge and a second lateral edge, the lower edge being convexly arcuate, the upper edge having a length being at least 12.0 inches and at most 36.0 inches, the first and second lateral edges each having a height being between 4.0 inches and 12.0 inches;
the panel comprising an inner wall and an outer wall attached together along respective outer edges thereof, the inner wall including the front side and the outer wall including the back side, each of the inner and outer walls being comprised of a cloth material, an interior space being defined between the inner and outer walls, the back side having a camouflage indicia positioned thereon;
the panel including an insulating material being positioned in the interior space, the insulating material inhibiting thermal conductivity between the front and back sides;
a coupler attaching the panel to a safety harness wherein the panel is configured to cover a buttocks of a person using the safety harness, the coupler including:
a pair of straps being attached to the panel and extending upwardly from the upper edge;
a pair of connectors, each of the straps having one of the connectors attached thereto, the connectors each being configured to engage a loop on the safety harness;
a plurality of sleeves being attached to the perimeter edge, the sleeves being positioned at least on the lower edge;
a tether extending through the sleeves, the tether having a first free end and a second free end, the tether being pulled to cinch the perimeter edge;
a pair of stops being attached to perimeter edge, the stops engaging the tether to releasably secure the tether relative to the perimeter edge, one of the stops being positioned adjacent to the first free end and one of the stops being positioned adjacent to the second free end; and
a pair of clips, each of the clips being positioned on the tether wherein one of the clips is positioned adjacent to one of the stops and one of the clips is positioned adjacent to another one of the stops, the clips being configured to engage strapping on the safety harness.

18. A system for insulating a buttocks of a harnessed person positioned in a tree, the system including:
a safety harness;
a panel being flexible and having a front side, a back side and a perimeter edge, the perimeter edge including an upper edge, a lower edge, a first lateral edge and a second lateral edge; and
a coupler attaching the panel to a safety harness wherein the panel is configured to cover a buttocks of a person using the safety harness to retain heat between the panel and the buttocks.

19. The system according to claim 1, wherein the panel comprises an inner wall and an outer wall attached together along respective outer edges thereof, the inner wall including the front side and the outer wall including the back side, an interior space being defined between the inner and outer walls, an insulating material being positioned in the interior space, the insulating material inhibiting thermal conductivity between the front and back sides.

20. The system according to claim 1, further including:
the coupler including:
a strap being attached to the panel and extending upwardly from the upper edge;
a connector being attached to the strap, the connector being configured to engage a loop on the safety harness;
a plurality of sleeves being attached to the perimeter edge, the sleeves being positioned at least on the lower edge; and
a tether extending through the sleeves, the tether having a first free end and a second free end, the tether being pulled to cinch the perimeter edge.
